(19) United States
(12) Patent Application Publication
(10) Pub. No.: US 2009/0157683 A1
(43) Pub. Date: Jun. 18, 2009

(54) Method and System for Accessing Selected Content

(76) Inventors: Sairam Bantupalli, Bangalore (IN); Anish Chandran, Bangalore (IN); Ranjith R1, Bangalore (IN); Darpan Saini, Pittsburgh, PA (US); Neeraj S. Sharma, Bangalore (IN)

Correspondence Address: IBM CORPORATION;INTELLECTUAL PROPERTY LAW, 11501 BURNET ROAD, AUSTIN, TX, 78758, US

(21) Appl. No.: 11/954,904

(22) Filed: Dec. 12, 2007

(51) Int. Cl. G06F 17/30

(52) U.S. Cl. 707/8; 707/E17.001

(57) ABSTRACT

A system, method and computer product for accessing content by receiving as input an anchor, where the anchor is associated with selected content within an existing document, the document for example being an existing web page, and upon selecting the anchor, displaying the selected content to the user. Also disclosed is a system, method and computer product for identifying content, creating an anchor for the selected content and transmitting the selected content to one or more users over a communication link.

### BACKGROUND OF THE INVENTION

1. Technical Field

This invention relates generally to a recipient accessing content received by means of an anchor, and more particularly to a recipient receiving an anchor pointing to highlighting content and directly accessing the highlighted content which is automatically displayed when the accessed by the recipient.

2. Description of the Related Art

The Internet, also referred to as an “internet-work”, is a set of computer networks, possibly dissimilar, joined together by means of gateways that handle data transfer and the conversion of messages from protocols of the sending network to the protocols used by the receiving network (with packets if necessary). When capitalized, the term “Internet” refers to the collection of networks and gateways that use the TCP/IP suite of protocols.

The Internet or the World Wide Web (www) as it is popularly known is a collection of documents, sometimes also referred to as web pages, that is accessible on the Web. The document or file which is written in XML (HTML, SGML etc.,) are typically stored on a server, for example a web server, and can be viewed over the Internet using a web browser, typically referred to as a client. The document or file on the Internet is identified by a unique identification, referred to as a unified resource locator (URL). A number of documents can be linked to each other in terms of the URL. The documents can be accessed by a uniform resource locator (URL) on the Internet, and typically a server that is connected to the Internet is dedicated to serving Web pages to a client or user.

A web page or “page” is an electronic document that integrates text and graphical information into a single interface, and a single page can have several other links or anchors to other pages defined within that particular page. Different web pages are linked together by means of hyperlinks. Web pages are often collected under one broad address or site. Usually, web pages are stored as HTML documents on a web server. Static pages show the same content each time they are viewed. Alternatively, web pages may be generated dynamically as they are accessed through the use of scripting language such as Active Server Pages (ASP), Java Server Pages (JSP), PHP, Perl, and others. Dynamic pages have content that can change each time they are accessed. A web server is generally a system such as a computer that is configured to provide HTTP services to HTTP clients (users). A web server stores web pages that are accessible to other computers, that may access the web pages using a typical web browser or a predefined user interface which can display the contents stored on a web server. Further, a web server offers security services to prevent unauthorized access to some or all of the web pages on the server.

Though there are several advantages of accessing content over the Internet using web servers and clients, a disadvantage with web pages is that it is not possible to have a link (such as a hyperlink) to an internal location within the webpage. Therefore, whenever a user wants to transmit a particular content on an existing web page to be viewed by another user, the main web page link or a link referencing an existing anchor within the web page is transmitted. Without a way to provide an improved method to access selected content to an existing web page to a user, the promise of this technology may never be fully achieved.

### SUMMARY

A method and data processing system for sharing content are provided in which an anchor is received as input, where the anchor is associated with selected content within a document and on accessing the anchor, the user being displayed with the selected content. Also, provided is a method and a data processing system for creating shared content where specified content is identified, an anchor is created for the specified content, wherein the specified content associated with the anchor consists of a different visual appearance from the unspecified content and transmitting the anchor to a designated set of recipients over a network. Advantages of the present invention involve the use of minimal overhead and no specific protocols being required, thereby saving time, cost and ease to implement. Additional embodiments are also disclosed.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings.

FIG. 1 depicts an exemplary embodiment of a network of data processing system 100 in which the present invention may be implemented.

FIG. 2 is an exemplary embodiment of a block diagram illustrating a data processing system 200 that may be implemented as a server in which the present invention may be implemented.

FIG. 3 is an exemplary embodiment of a block diagram illustrating a data processing system that may be implemented as a client computer 300 in which the present invention may be implemented.

FIG. 4A is an exemplary embodiment of a document 400 in accordance with the present invention.

FIG. 4B is another exemplary embodiment of a document 400 in accordance with the present invention.

FIG. 4C is another exemplary embodiment of a document 400 in accordance with the present invention.

FIG. 5 is an exemplary embodiment of a document 500 in accordance with the present invention.

FIG. 6 is another exemplary embodiment of a method 600 implemented in accordance with the present invention.

FIG. 7 is another exemplary embodiment of a method 700 implemented in accordance with the present invention.

### DETAILED DESCRIPTION

The following is intended to provide a detailed description of an example of the invention and should not be taken to be limiting of the invention itself. Rather, any number of variations may fall within the scope of the invention, which is defined in the claims following the description.

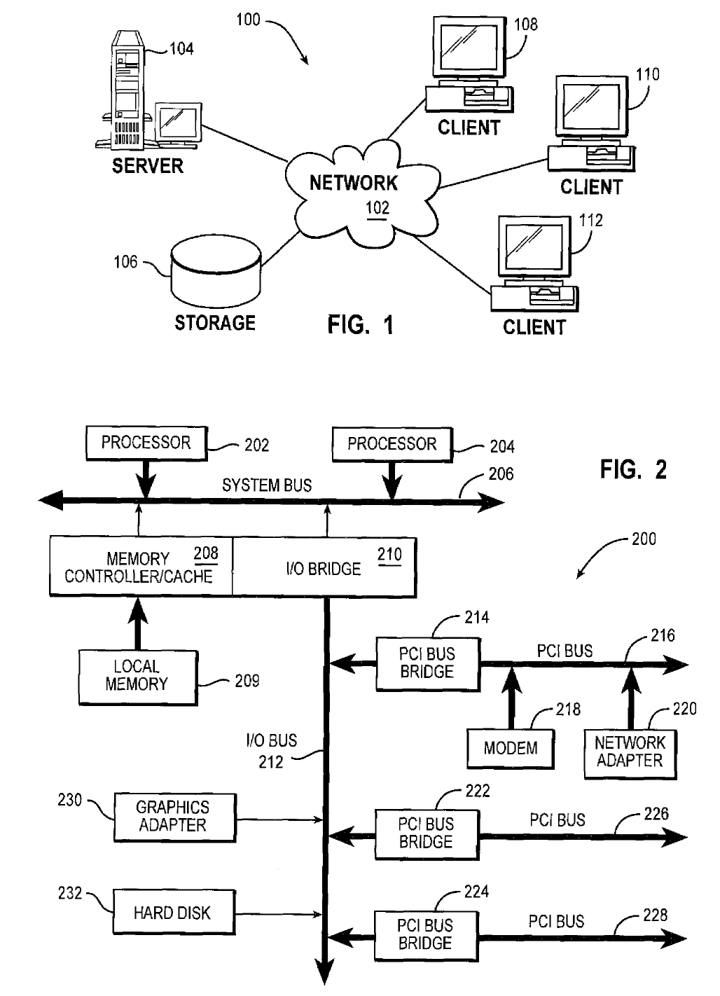

FIG. 1 depicts an exemplary embodiment of a pictorial representation of a network of data processing system in which the present invention may be implemented Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as boot files, operating system images, and applications to clients 108-112. Clients 108, 110, and 112 are clients to server 104. Network data processing system 100 may include additional servers, clients, and other devices not shown. In the depicted example, network data processing system 100 is the Internet with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention and a person skilled in the art will appreciate that various other implementation of this system fall within the scope of the present invention.

Referring to FIG. 2, an exemplary embodiment of a block diagram illustrating a data processing system that may be implemented as a server 104 of FIG. 1 in which the present invention may be implemented is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to network computers 108-112 in FIG. 1 may be provided through modem 218 and network adapter 220 connected to PCI local bus 216 through add-in boards. Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention. The data processing system depicted in FIG. 2 may be, for example, an IBM e-Server pSeries system, a product of International Business Machines Corporation in Armonk, N.Y., running the Advanced Interactive Executive (AIX) operating system or LINUX operating system.

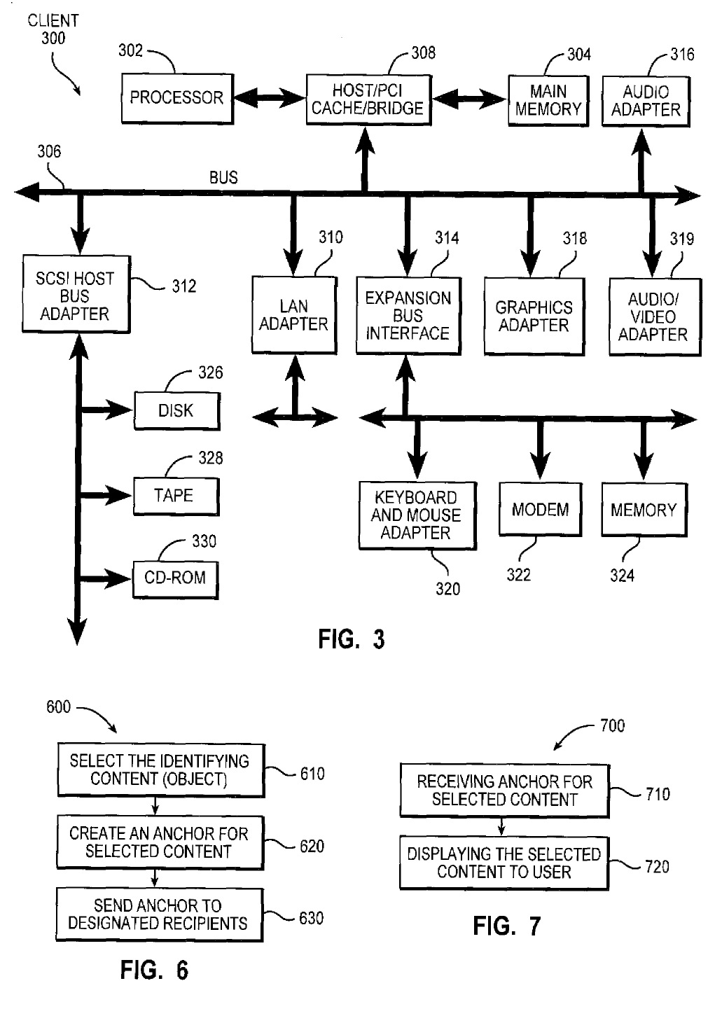

FIG. 3 is an exemplary embodiment of a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows 2000, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302. Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3. Also, the processes of the present invention may be applied to a multiprocessor data processing system.

A further example of the data processing system 300 may be a stand-alone system configured to be bootable without relying on some type of network communication interface, whether or not data processing system 300 comprises some type of network communication interface. As a further example, data processing system 300 may be a Personal Digital Assistant (PDA) device, mobile phone etc., which is configured with ROM and/or flash ROM in order to provide non-volatile memory for storing operating system files and/or user-generated data. The depicted example in FIG. 3 and above-described examples are not meant to imply architectural limitations. For example, data processing system 300 also may be a notebook computer or hand held computer in addition to taking the form of a PDA. In one embodiment, the data processing system 300 also may be a kiosk or a Web appliance.

The software may be stored in a computer readable medium, including the storage devices described below, for example. The software is loaded into the computer system 200, 300 from the computer readable medium, and then executed by the computer system. A computer readable medium having such software or computer program recorded on it is a computer program product. The use of the computer program product in the computer system preferably effects an advantageous apparatus for performing the method as implemented by the present invention. Further, the method of the present invention consists in receiving a data signal containing functional requirements from a readable medium, the data signal when executed on a processor capable of performing the method as described within the scope of the present invention

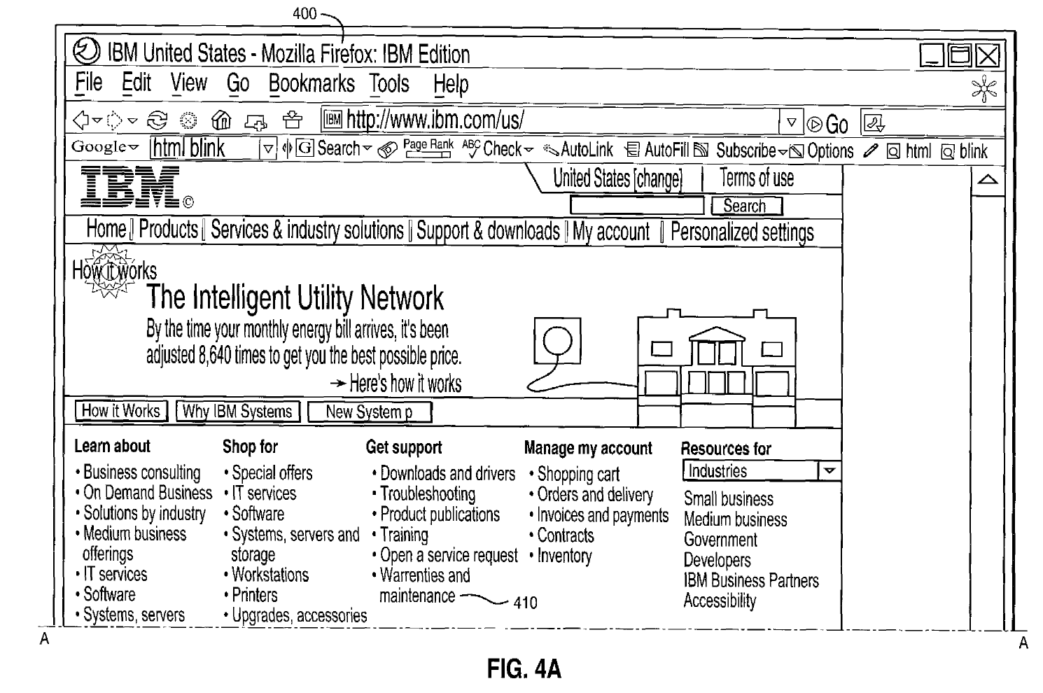

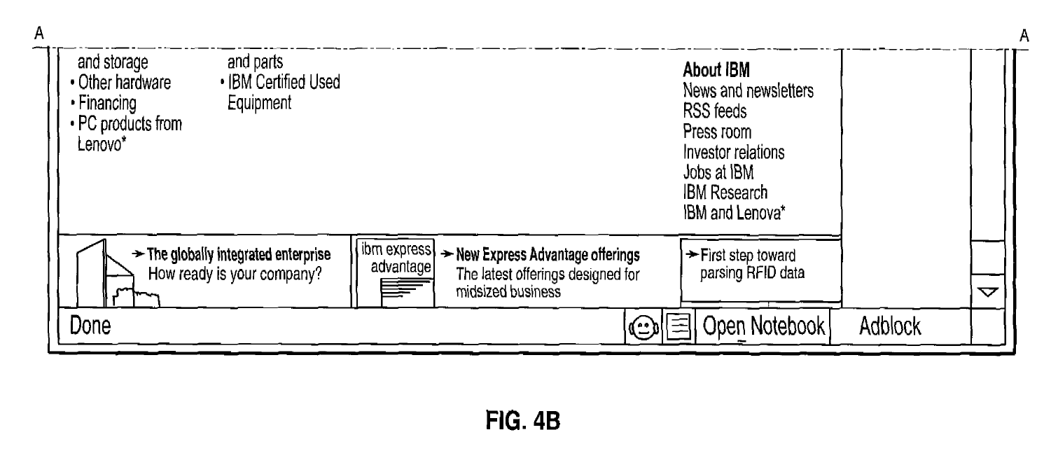

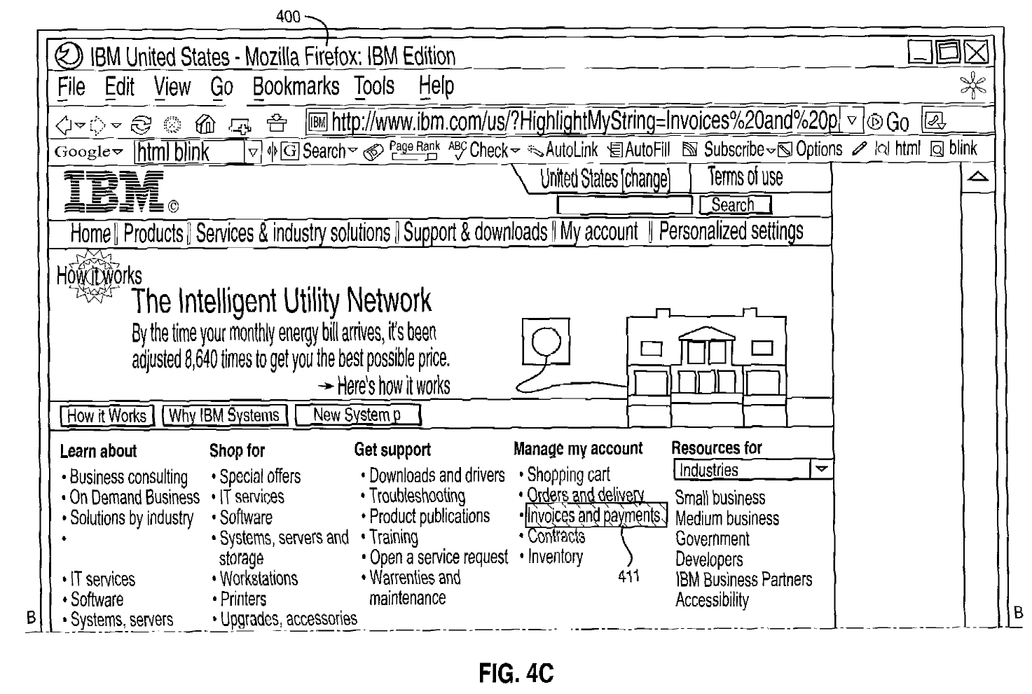

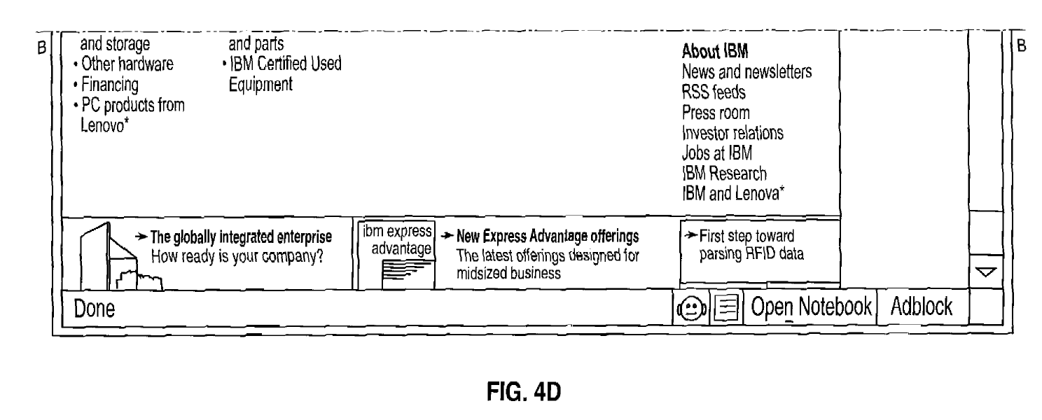

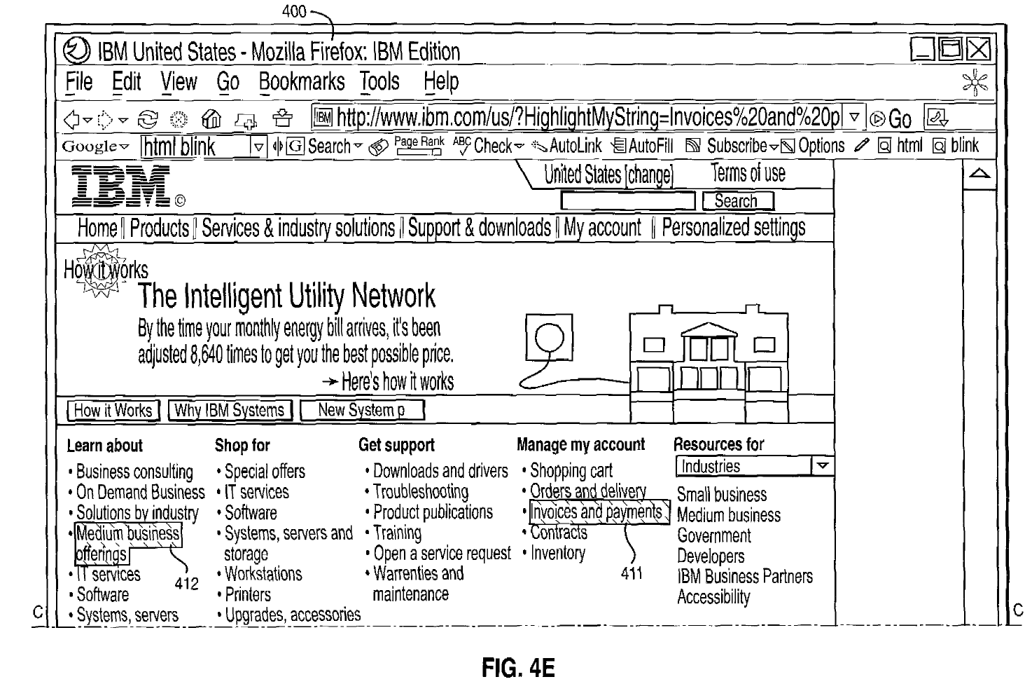

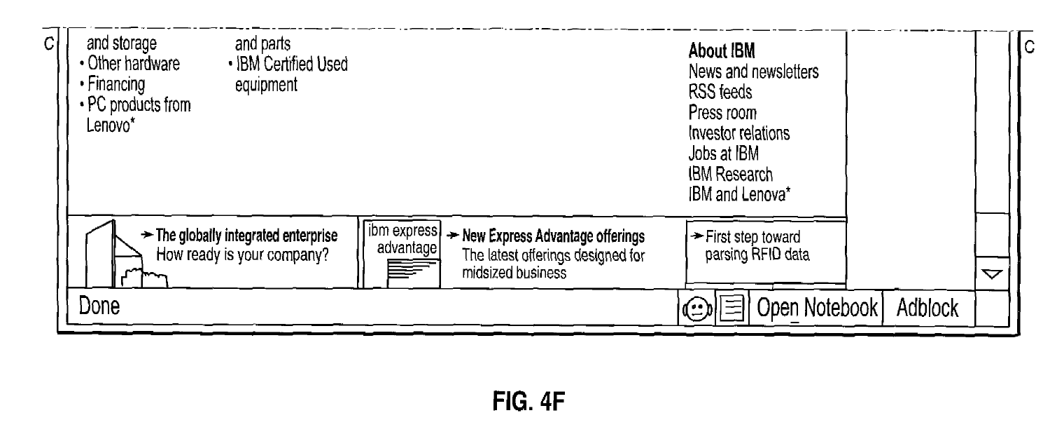

FIG. 4A is an exemplary embodiment of a document 400 in accordance with the present invention. For example, a Web page is a document 400 that is available on the Web (Internet), and identified by a unique URL (Uniform Resource Locator). The document 400 may consist of static or dynamic pages. The document 400 consists of a variety of content 410, which for example can consists of headers, text, images, static content, dynamic content, other URL's etc. The document 400 shown in FIG. 4 is a web page and is only for the purpose of illustrations, and it should be appreciated by a person skilled in the art that various other forms of document where content is stored and can be displayed on either a server or a client fall within the scope of this invention. Any computer file, document, or grouping of electronic text which can be addressed by a reference such as a hypertext link and rendered for a user on his/her computer monitor, including any grouping of electronic text, graphical material, or data generated by a software application and displayed, for example through the use of a Web browser, fall within the scope of this invention. The document 400 is typically stored on a server 200 and can be accessed and displayed on a client 300. Usually, web pages 400 are stored as HTML documents on a web server. Alternatively, web pages may be generated dynamically as they are accessed through the use of scripting language such as Active Server Pages (ASP), Java Server Pages (JSP), PHP, Perl etc. One skilled in the art will appreciate the difference among a link to a document (such as a hyperlink) and an anchor embedded in an existing document to which a link may refer thereto.

In the document 400 of FIG. 4B, a first user desires to display the text “Invoices and payments” to a second user. The first user creates an anchor to the selected text 411 “Invoice and Payments” by embedding the information that is available within the link, for example creating an anchor in the form of http://www.ibm.com/?HighlightMyString=Invoice and payments, and transmitting that anchor to the second user. When the second users receives the anchor and accesses the anchor, the second user is directly taken to a document (not shown in the Figure) that is related to “Invoice and Payments” as shown in FIG. 4B, which relates specifically to the contents of “Invoice and payments”. In one embodiment, instead of taking the second user directly to the content of “Invoice and Payments” the second user will be displayed with the document 400 where the link “Invoice and Payments” will have a different visual appearance 411, for example the selected content will be highlighted in a different color. Once an anchor is created, the user may choose to manually or automatically transmit the anchor to a list of recipients that may be displayed to the first user. In one embodiment, the content is dynamically tagged to create an anchor. In a further embodiment, highlighting/marking is performed on the server side wherein the server renders the page in memory and returns only the tagged portion of the page to the requesting browser. This way, the user only views only what is sent/transmitted (nothing extra) and bandwidth is accordingly saved as the entire page is not loaded by the client and no plug-in is needed on client side. By rendering the page at the server-side ensures that this can be done even for active objects as well.

FIG. 4C illustrates an exemplary embodiment where the first user has selected content 411, 412 and required to send the first selected content 411 to a second user and the second selected content 412 to a third user. As discussed previously in FIG. 4B, anchors are created and transmitted to the respective users. On receiving the anchors, the second user is directed to the link 411 “Invoice and Payment” or directly to the contents of this site and the third user is directed to the link 412 which is related to “Medium Business Offering” or directly to the contents of this site, as chosen by the first user. It should be apparent to a person skilled in the art that though only text highlighting has been shown, the same or similar technique may be implemented for images, audio, video and other forms of content and these fall within the scope of this invention.

Consider the following portion from a not so unheard of email conversation
>>Where is the sizeable group of people that want to evolve gcc in a way >>that rms/FSF does not approve of?
>A compiler is not something people have much emotional attachment to. If >the language to be compiled is a given (e.g., an ANSI standard), there isn't >much room for people to invent new features. An operating system has >unlimited opportunity for people to implement their own favorite features.
WELL, THERE'S GNU EMACS . . . DON'T TELL US PEOPLE HAVEN'T GOT EMOTIONAL ATTACHMENT TO EDITORS:)
   As is evident, the simple method of prefixing lines from the quoted(forwarded or replied) text with a “>” helps to structure the conversation. A user without much background knowledge on the subject material will also be able to appreciate that the LAST TWO LINES belong to the author of the mail and that it is specifically in response to the lines in italics which in turn happen to be a response to the material represented by the lines in bold i.e., first two lines. A strong critique can still say that, this is about a lot of redundant text material or that this scheme obscures even the relative fact of whether the author of the first two and the LAST TWO lines are same or different. While true, trying to fix it would render email conversations inelegant and unsuitable.

Let's port this example to a blog scenario. The first two lines will be part of the first (in time) post. The lines in italics may then be a part of a second (in time) post which shall quote a link to the particular text in the first post, before providing the comments. The LAST TWO LINES will then be part of a third (in time) post linking to the particular text in the second post.

In addition to leverage hyperlinks to reduce redundant data, as well as fitting with the web pattern, there are two significant advantages that the blog format offers.
The same post can address text (i.e. quote information) in multiple posts by multiple authors as there is no concept of conversation.
While referring to the quoted text, a user is seeing the actual content i.e. the whole document (article) containing the quoted information presented in its native format, there to be seen. As a result there can be no missing/misreading the context.
   In fact a large amount of blog content can do this i.e., analyze information presented elsewhere. Quoting inline if done is a step backward. Also there is the question of lacking context/authority. There could possibly not be a better method than being able to link exactly to the referred material.

For example, An ecologist is planning to blog on the effects of tweaking the traditional crop patterns and would like to quote certain paragraphs in this regard from the online article http://www.narmada.org/gcg/gcg.html. Checked out the article? Well that covers a multitude of issues and is reasonably long. Now how does the ecologist quote what he/she wants to quote? Quoting such long text as ‘inline’ would not only distort his/her own content but causes to miss out on providing context or authority to the quoted content. If he/she were to link, he/she has to specify the URL, http://www.narmada.org/gcg/gcg.html, and ask the user (reader) to scroll down to the 191^{st} paragraph and read the next 5 paragraphs from there on.

Hyperlinks are one of the prominent reason for the success of the World Wide Web. The number of links in a page is taken to be more or less directly proportional to the usefulness of content or popularity of the page. It is the ability to link to a page without the ‘knowledge of’/‘support from’ the page itself that attribute to the power of hyperlinks. Internal hyperlinks is one simple and very common example of their usage for a document (article) spanning a webpage and consisting of an “index”/“table of contents” to link to different sections within an article in a web page. However what contributes to the inability to extend their use is that there cannot be a link to a region in a webpage unless there is an explicit anchor defined by its owner/author at that point when the page is created.

One reason the above inability did not show up earlier is due to the consumption of internal hyperlinks being limited from within the same page or from mutually aware pages (pages from the same site etc). But as demonstrated previously, for example blogs require to ‘quote from’/‘refer to’ paragraphs or sentences contained with in other articles where the referred article laid out as a webpage may not have any anchors defined for the particular paragraph/sentence to be referred.

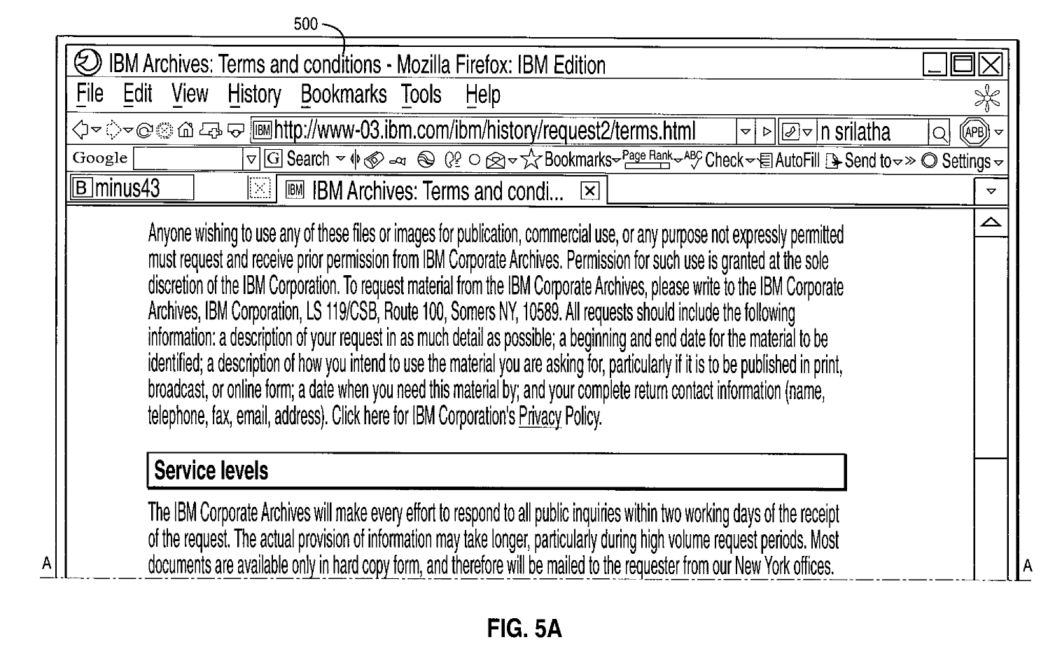

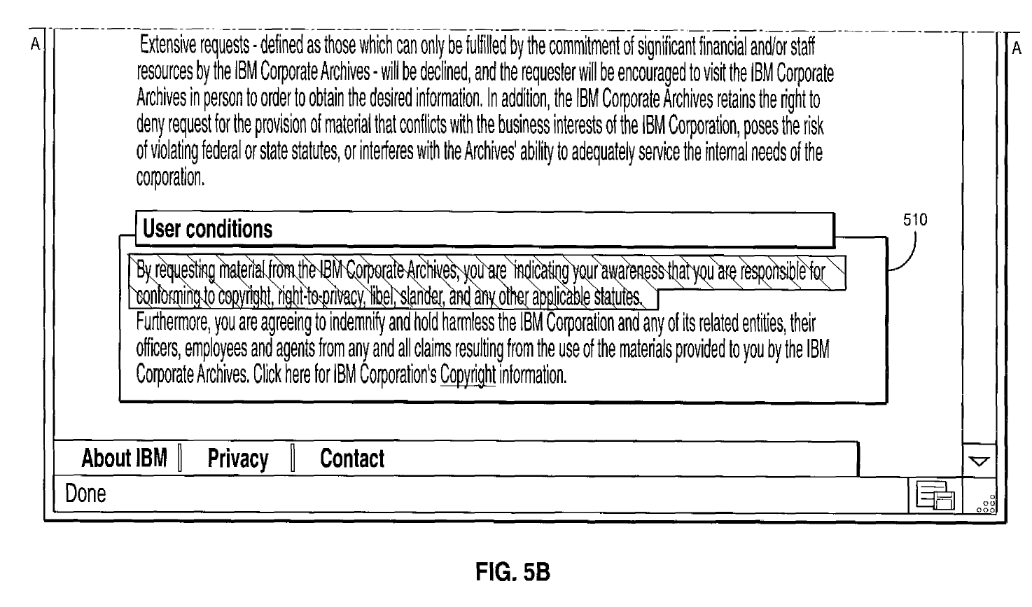

FIG. 5 illustrates an exemplary embodiment of a document 500 where an anchor is created for the selected content 510. The selected content is identified by means of an anchor and the anchor when received by the user over a communication link displays the specified exact content that has been selected.

FIG. 6 illustrates and exemplary embodiment of a method 600 for creating an anchor with respect to the selected content. In step 610 first the content is identified and selected for example by using mouse/pointing device. In step 620, an anchor is created for the selected content, for example in the form of a link—http://ww-03.ibm.com/ibm/history/request2/terms.html?para=4;textstart=“byrequesting”;lines=1), which may be done by means of using context menu by setting appropriate property/methods. In one embodiment after creating the anchor, it can be stored by copying to a file or clipboard. In step 630, once the anchor has been created and the designated set of recipients can be identified, the anchor can be transmitted to the designated set of recipients for example via a communication link (email/instant message etc).

The designated set of recipients may be provided automatically by the system or may be manual chosen by the user from a list that may be displayed to the user. While creating the anchor for the selected content, different visual appearances can be created for the selected content based on the choice of the user, for example highlighting the content etc. The unselected content will have a different visual appearance from the selected content. In one embodiment, the selected content may be stored in a data structure. For example, the anchor is communicated over a communication link which could include an electronic mail, where the anchor can either be located in the body of the electronic mail message or may be provided as an attachment with the message.

FIG. 7 illustrates an exemplary embodiment of a method 700 of receiving the anchor and displaying the selected content. As discussed previously, in step 710 a user (receiver) receives the anchor over a communication link, and is configured to perform various activities on the anchor such as reading the anchor. In one embodiment the user may be configured to interpret known property/methods embedded in the link of the anchor, in this case those will be para=4;textstart=“by requesting”;lines=1. Interpretation of above data is as follows: go to the 4th paragraph, highlight the text starting “by requesting” till next line. Next, detach this interpreted content from the anchor and send the remaining content to the target webserver as http://www-03.ibm.com/ibm/history/request2/terms.html in this case. In step 720 open the page, once the page is loaded on the viewing window (browser or any other application) implement the interpretation done in step 720 and make that “highlighted” area visible by scrolling to appropriate location automatically. In one embodiment, the step 710 may involve decoding the anchor, if the anchor has been encoded by the sender. The selected content has a different visual appearance from the unselected content and the selected content may be stored in a data structure.

One of the preferred implementations of the invention is a client application, namely, a set of instructions (program code) in a code module that may, for example, be resident in the random access memory of the computer. Until required by the computer, the set of instructions may be stored in another computer memory, for example, in a hard disk drive, or in a removable memory such as an optical disk (for eventual use in a CD ROM) or floppy disk (for eventual use in a floppy disk drive), or downloaded via the Internet or other computer network. Thus, the present invention may be implemented as a computer program product for use in a computer. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the required method steps.

The accompanying figures and this description depicted and described embodiments of the present invention, and features and components thereof. Those skilled in the art will appreciate that any particular program nomenclature used in this description was merely for convenience, and thus the invention should not be limited to use solely in any specific application identified and/or implied by such nomenclature. Therefore, it is desired that the embodiments described herein be considered in all respects as illustrative, not restrictive, and that reference be made to the appended claims for determining the scope of the invention.

While particular embodiments of the present invention have been shown and described, it will be obvious to those skilled in the art that, based upon the teachings herein, that changes and modifications may be made without departing from this invention and its broader aspects. Although the invention has been described with reference to the embodiments described above, it will be evident that other embodiments may be alternatively used to achieve the same object. The scope of the invention is not limited to the embodiments described above, but can also be applied to software programs and computer program products in general. It should be noted that the above-mentioned embodiments illustrate rather than limit the invention and that those skilled in the art will be able to design alternative embodiments without departing from the scope of the appended claims. In the claims, any reference signs should not limit the scope of the claim. The invention can be implemented by means of hardware comprising several distinct elements. Therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. A method in a data processing systems for sharing content, the method comprising:
receiving as input an anchor, the anchor associating selected content within an existing document;
selecting the received anchor by a user; and
displaying the selected content to the user in response to selecting the anchor.

2. The method of claim 1, wherein displaying the selected content comprising decoding the anchor.

3. The method of claim 2, wherein the selected content comprises a different visual appearance from unselected content of the existing document.

4. The method of claim 3, wherein the selected content is highlighted.

5. The method of claim 1, further comprising storing the selected content in a data structure.

6. The method of claim 1, wherein the anchor is received over a communication link.

7. The method of claim 6, wherein the communication link includes an electronic mail message.

8. The method of claim 7, wherein the anchor is located in a body of the electronic mail message or in an attachment to the electronic mail message.

9. A method in a data processing system for creating shared content, the method comprising:
identifying specified content within an existing document;
creating an anchor for the specified content; and
sending the anchor to a designated set of recipients.

10. The method of claim 9, further comprises encoding the anchor with instructions for displaying the specified content.

11. The method of claim 9, wherein the designated set of recipients is automatically identified from a list of recipients.

12. The method of claim 9, wherein the specified content comprises a different visual appearance from unspecified content of the existing document.

13. The method of claim 9, further comprising storing the specified content in a data structure.

14. The method of claim 9, wherein the anchor is transmitted over a communication link.

15. The method of claim 14, wherein the communication link includes an electronic mail message, and the anchor being located in a body of the electronic mail message or in an attachment to the electronic mail message.

16. A data processing system for sharing content, the data processing system comprising a processing unit comprising:
receiving means for receiving as input an anchor over a communication network,
the anchor associating selected content within an existing document;
selecting means for selecting the anchor by a user; and
displaying means for displaying the selected content to the user in response to selecting the anchor.

17. A data processing system for creating shared content, the data processing system comprising:
means for identifying specified content within an existing document;
means for creating an anchor for the specified content, wherein the specified content comprises a different visual appearance from unspecified content of the existing document; and
means for sending the anchor to a designated set of recipients.

18. The data processing system of claim 17, further comprising
means for automatically identifying a designated set of recipients wherein the designated set of recipients are selected from a list of recipients.

19. A method in a data processing system for sharing content from an existing web page, the method comprising:
connecting a computing device to a service provider hosting the existing web page;
running a browser on the computing device;
accessing the web page using the browser on the computing device;
identifying selected content within the web page;
creating an anchor for the selected content; and
sending the anchor to a designated set of recipients over a communication link.

20. A computer program product comprising a computer usable medium having computer usable program code for sharing content from a web page, said computer program product including:
computer usable program code for receiving as input an anchor, the anchor associating selected content within an existing document;
computer usable program code for selecting the anchor by a user; and
computer usable program code for displaying the selected content to the user in response to selecting the anchor.
